(19) United States
(12) Patent Application Publication
(10) Pub. No.: US 2019/0239702 A1
(43) Pub. Date: Aug. 8, 2019

(54) Shower Device, And Multifunctional Shower Device

(71) Applicant: VIBRATHERM CORPORATION, Nagano (JP)

(72) Inventor: Masaru MIYAZAWA, Nagano (JP)

(73) Assignee: VIBRATHERM CORPORATION, Nagano (JP)

(21) Appl. No.: 16/341,886

(22) PCT Filed: Nov. 6, 2017
(86) PCT No.: PCT/JP2017/039885

§ 371 Date: Apr. 12, 2019

(30) Foreign Application Priority Data
Nov. 7, 2016 (JP) 2016-217184

(51) Int. Cl. A47K 7/04; B05B 1/18; B05B 1/02

(52) U.S. Cl. CPC A47K 7/046; B05B 1/02; B05B 1/185

(57) ABSTRACT

The present invention provides a shower device including a mountable attachment having functions of, for example, a massage and a body brush. The shower device according to the present invention includes a grip including a water feeding channel therein, and a shower head including a showering water chamber provided with a sprinkling plate and a fin-driving water chamber behind the showering water chamber, in which the fin-driving water chamber accommodates a fin rotatable by running water. The fin-driving water chamber has an outer face to which an attachment is mountable, and the fin-driving water chamber includes a first cooperating rotary shaft (A) to transmit a rotational motion of the fin to the attachment after being mounted, in which the first cooperating rotary shaft (A) extends from the fin-driving water chamber and is coaxial with a rotary shaft of the fin.

### TECHNICAL FIELD

The present invention relates to a shower device including a shower head to which an attachment is mountable, and a multifunctional shower device including an attachment mounted to a part of the shower head of the shower device. In particular, the present invention relates to a shower device including a shower head having a fin-driving water chamber accommodating fins rotatable by running water in the chamber and can transmit the rotational motion of the fins to an attachment mountable to the outer face of the fin-driving water chamber, and a multifunctional shower device, in which a function of, for example, massaging, body brushing, and dead skin exfoliation is provided by an attachment mounted to a part of the shower head of the shower device.

### BACKGROUND ART

Shower devices having massage function are known that have a shower head generating pulsating running water to discharge the water from ejection nozzles of the heads, and that have a massage shower head including water wheels rotatable by the running water for generation of vibrations. For example, Patent Document 1 discloses a vibratory shower device including a main body of the shower device, a water wheel disposed in the main body and rotatable by influent water, an eccentric rotor held by a rotary shaft of the water wheel, and a means for varying the direction of the water fed to the water wheel. Patent Document 2 discloses a massage device having nozzles that can vary the direction of water fed to a water wheel without a variation in the flow rate of influent water, in which the variation in the direction of the fed water also varies the rotation rate of the water wheel and eventually the vibration frequency of the massage device.

Patent Document 3 discloses a massage device that can massage the head of a user during washing of his/her hair, which includes a water wheel rotatable by running water, a vibrator, and a converting mechanism that converts the rotational motion of the water wheel into the axial vibrational motion of the vibrator, in which the vibrator vibrates to produce the massaging effect. Patent Document 4 discloses a shower head that can generate pulsating running water without a variation in the direction of the running water, which includes a rotor and a water stop at the ejection side of the shower head, in which the water stop is movable by the rotational motion of the rotor to partially close ejection nozzles. Patent Document 5 discloses a massage shower head including an impeller, a sprinkling plate at a discharging end of the shower head, and a water chamber inboard from the sprinkling plate, in which the impeller is disposed in the water chamber to appropriately rotate and discharge showering water for massage, and multiple annular inlets are defined in the inner wall to feed swirling water into the impeller.

### PRIOR ART DOCUMENTS

### Patent Documents

Patent Document 1: JP 2006-271849 A

Patent Document 2: JP 2006-271850 A

Patent Document 3: JP 11-47211 A

Patent Document 4: JP 07-100408 A

Patent Document 5: JP 05-115520 A

### SUMMARY OF THE INVENTION

### Problem to be Solved by the Invention

The shower device disclosed in Patent Document 1 has both vibrating and showering functions, which cannot be switched. In the massage device and the shower device disclosed in Patent Document 2, the massage device is a separate component from the shower device. The massage device disclosed in Patent Document 3 can switch between a massaging mode and a simultaneous showering and massaging mode. The massage shower heads disclosed in Patent Documents 4 and 5 produce pulsating running water. Unfortunately, none of the shower devices in the Patent Documents 1 to 5 switches between the showering function and the massaging function.

An object of the present invention, which has been made in view of the above-mentioned problem in the prior arts, is to provide a shower device and a multifunctional shower device. The shower device includes a shower head with a showering water chamber and a fin-driving water chamber, in which the switching of water to the showering water chamber or to the fin-driving water chamber allows the shower device to function as a shower or to transmit the rotational motion of a fin to an attachment mounted to the outer face of the fin-driving water chamber for operation of the attachment. The multifunctional shower device provides various functions, for example, a massaging function, a body brushing function, and a dead skin exfoliation function using attachments mountable to the shower device.

### Means of Solving the Problem

In view of the above-mentioned prior arts, the inventor has disposed a showering water chamber and a fin-driving water chamber in a shower head of a shower device. In this configuration, the rotational motion of a fin has been transmitted to an attachment mounted to the outer face of the fin-driving water chamber during feeding of water into the fin-driving water chamber. The inventor has discovered that the mounted attachments can provide their own functions, for example, massaging, body brushing, and dead skin exfoliation and has completed the present invention. The invention includes the following first and second aspects.

(1) A shower device (hereinafter referred to as a first embodiment, if needed) including a grip including a water feeding channel therein, and a shower head including a showering water chamber provided with a sprinkling plate and a fin-driving water chamber behind the showering water chamber, in which the fin-driving water chamber accommodates a fin rotatable by running water. The fin-driving water chamber has an outer face to which an attachment is mountable, and the fin-driving water chamber includes a first cooperating rotary shaft (A) to transmit a rotational motion of the fin to the attachment after being mounted, in which the first cooperating rotary shaft (A) extends from the fin-driving water chamber and is coaxial with a rotary shaft of the fin.

(2) A multifunctional shower device (hereinafter referred to as a second embodiment, if needed) including a shower device including a grip including a water feeding channel therein and a shower head including a showering water chamber provided with a sprinkling plate and a fin-driving water chamber behind the showering water chamber, in which the fin-driving water chamber accommodates a fin rotatable by running water, and an attachment mounted to the outer face of the fin-driving water chamber. The fin-driving water chamber includes a first cooperating rotary shaft (A) to transmit a rotational motion of the fin to the attachment after being mounted, in which the first cooperating rotary shaft (A) extends from the fin-driving water chamber and is coaxial with a rotary shaft of the fin. The mountable attachment includes a second cooperating rotary shaft (B) cooperating with the first cooperating rotary shaft (A), in which the attachment is operable by the rotational motion transmitted from the fin-driving water chamber.

### Effect of the Invention

The shower device according to the present invention has a structure that can mount and dismount an attachment operable by the transmitted rotational motion of a fin, and the mount of a massage attachment, a body brushing attachment, or a dead skin exfoliation attachment to the shower device achieves a compact shower device because a single shower device has various functions. Since no electric power is used for rotation of the fin, the electric leakage can be avoided. The multifunctional shower device according to the present invention has a structure that can mount and dismount various types of attachments; hence, the device can have functions of, for example, showering, massaging, body brushing, and dead skin exfoliation according to needs. Furthermore, these mountable and dismountable attachments can be ready replaced, resulting in high convenience and functionality.

### BRIEF DESCRIPTION OF DRAWINGS

FIG. 1 is an external view of a multifunctional shower device including a shower head provided with a massage attachment.

FIG. 2 is an external view of a multifunctional shower device including a shower head provided with a body brushing attachment.

FIG. 3 is an external view of a multifunctional shower device including a shower head provided with a dead skin exfoliation attachment.

FIG. 4 is a cross-sectional view of a shower head provided with a massage attachment.

FIG. 5 is a cross-sectional view of a shower head provided with a body brushing attachment.

FIG. 6 is a cross-sectional view of a shower head provided with a dead skin exfoliation attachment.

FIG. 7 is an exploded perspective view illustrating a shower head, a body brushing attachment, and a grip.

FIG. 8 is an exploded perspective view of a grip.

FIG. 9 is an exploded perspective view of a shower head.

FIG. 10 is an exploded perspective view of a massage attachment.

FIG. 11 is an exploded perspective view of a body brushing attachment.

FIG. 12 is an exploded perspective view of a dead skin exfoliation attachment.

FIG. 13 is a cross-sectional view of a shower head taken along line A-A in FIG. 4.

### MODE FOR CARRYING OUT THE INVENTION

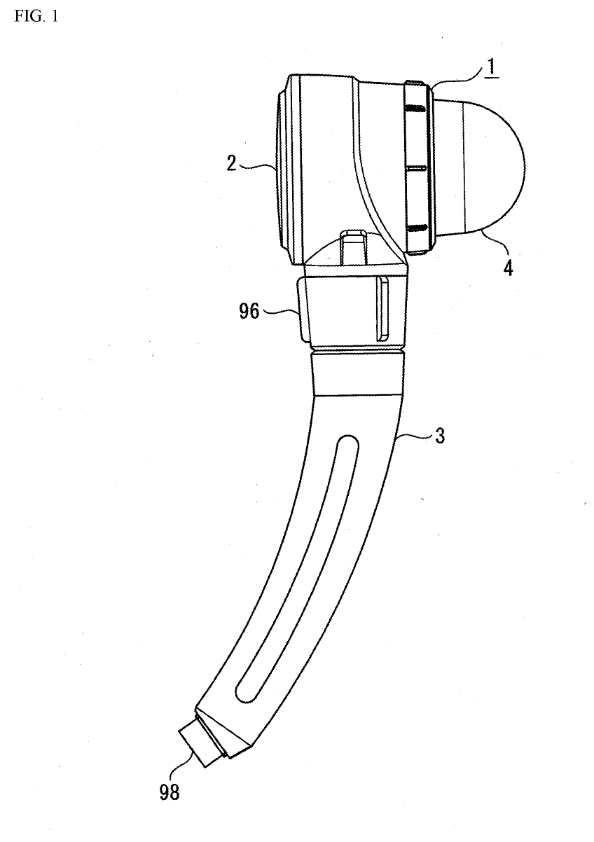

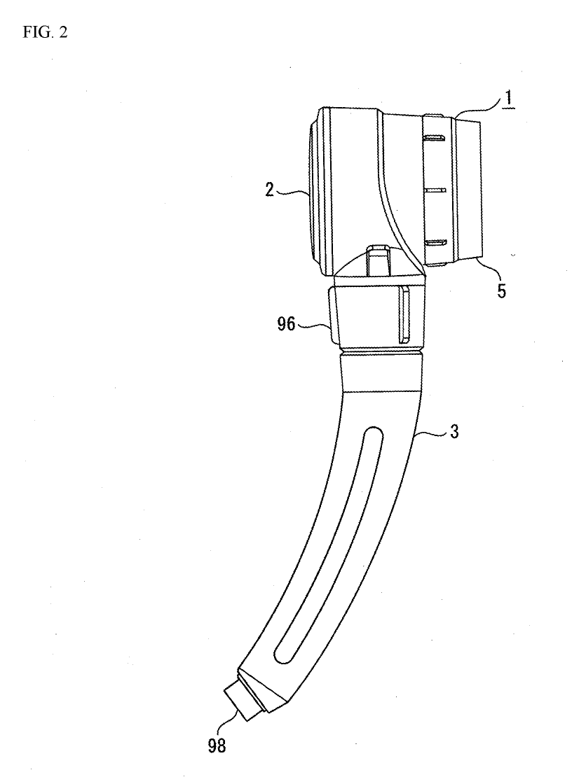

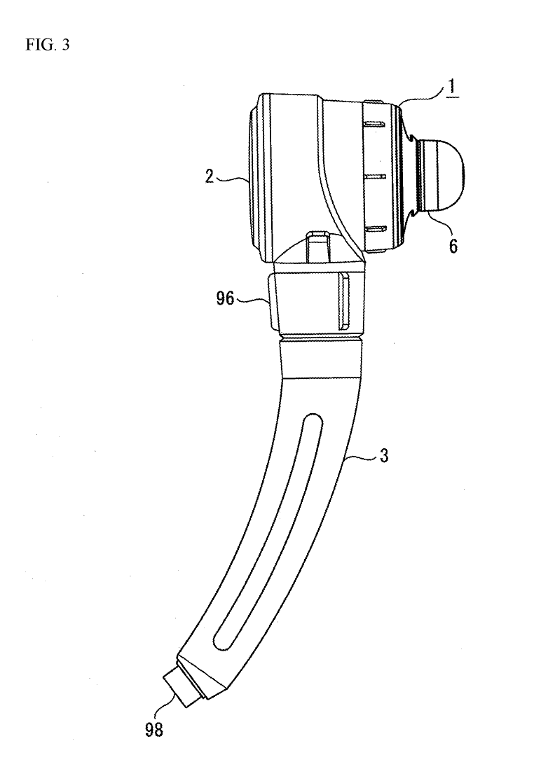

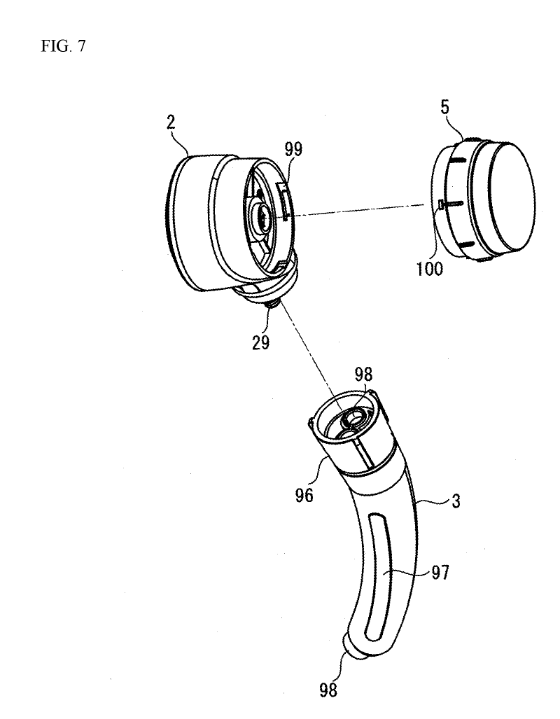

With reference to FIGS. 1 to 13, an exemplary shower device (first embodiment) and an exemplary multifunctional shower device (second embodiment) according to the present invention will now be described. The following description is an exemplary embodiment, and the scope of the invention should not be limited to the embodiment shown in FIGS. 1 to 13. FIGS. 1, 2, and 3 are external views of a multifunctional shower device 1 according to the second embodiment of the invention. The multifunctional shower device 1 includes a shower head 2 of the shower device provided with an attachment of a massage attachment 4, a body brushing attachment 5, or a dead skin exfoliation attachment 6, respectively. As illustrated in FIG. 7, the shower device according to the present invention includes a shower head 2 and a grip 3.

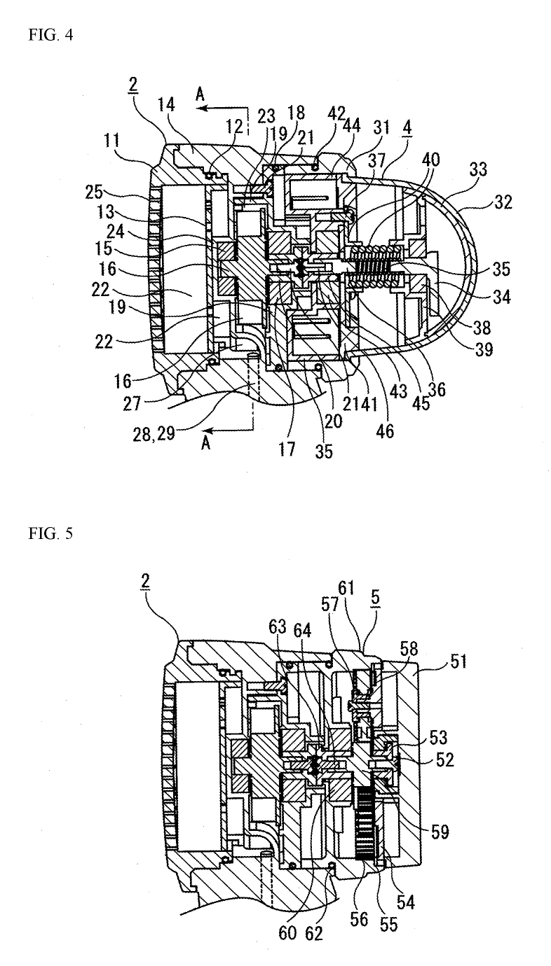

FIGS. 4 to 6 are cross-sectional views of the shower head 2 to which the massage attachment 4, the body brushing attachment 5, and the dead skin exfoliation 6, respectively, are mounted. FIGS. 4 to 6 each illustrate the second embodiment according to the present invention including these attachments. The shower head 2 before the mount of the attachments corresponds to the first embodiment according to the invention. The shower head 2 in FIG. 4 has an outer face composed of a main head body 14, a sprinkling plate 11, and a fin holder 19. The shower head 2 accommodates a showering water chamber 22 and a fin-driving water chamber 23 behind the showering water chamber 22 inside the shower head 2. The showering water chamber 22 and the fin-driving water chamber 23 are partitioned by a partition wall 24. The showering water chamber 22 accommodates a watering guide 13. The sprinkling plate 11 has sprinkling holes 25.

As illustrated in FIG. 13, the fin-driving water chamber 23 is placed inside the fin holder 19, and include a fin 16 that can be rotated by running water injected from a fin nozzle 26. The fin 16 has a rotary shaft that is adjacent to the sprinkling plate 11 and held by a bearing 15. A first cooperating rotary shaft (A) 20 to transmit the rotational motion of the fin to the rotary shaft of the attachment side is disposed at the attachment side and can cooperate with one end of a second cooperating rotary shaft (B). The rotary shaft of the attachment side is held by a bearing 17. An O-ring 12 and an O-ring 18 are respectively disposed between the main head body 14 and the sprinkling plate 11 and between the main head body 14 and fin holder 19 to provide sealing therebetween.

The massage attachment 4 illustrated in FIG. 4 has an outer face composed of a vibrator body 31, a vibrator rubber 32, and a vibrator base 44. An O-ring 42 is disposed between the vibrator body 31 and the head 11 to provide sealing therebetween. The massage attachment 4 includes a second cooperating rotary shaft (B) 45 rotatable in cooperation with the first cooperating rotary shaft (A) 20 extending from the fin-driving water chamber 23, a spring shaft 36, a rotary spring 35, and an eccentric rotor 34 in this order which are rotatable. The eccentric rotor 34 converts the rotational motion of the fin 16 into a vibrational motion and transmits the vibrational motion to the vibrator rubber 32. The rotary spring 35 is provided with a fixing spring 40 around the outer circumference for a reduction in load onto the rotary spring 35. The eccentric rotor 34 has a rotary shaft held by a bearing 38, and the bearing 38 is held by an inner vibrator casing 39.

In FIG. 5, the components of the shower head are denoted by the same reference numerals as those in FIG. 4 and are not described. The body brushing attachment 5 illustrated in FIG. 5 has an outer face composed of a brush body 61 and a brush base 51. An O-ring 62 is disposed between the brush body 61 and the main head body 14 to provide sealing therebetween. The body brushing attachment 5 includes a second cooperating rotary shaft (B) 63 rotatable in cooperation with one end of the first cooperating rotary shaft (A) 20 extending from the fin-driving water chamber 23, a sun gear 59, planetary gears 56, and an internal gear bush 55 that provide a planetary reduction gear mechanism for a reduction in rotation rate of the second cooperating rotary shaft (B) 63, and a rotation base 54 in this order. The rotation rate of the second cooperating rotary shaft (B) 63 is reduced to that of the rotation base 54 by the reduction gear mechanism, and the rotation of the rotation base 54 is transmitted to the brush base 51.

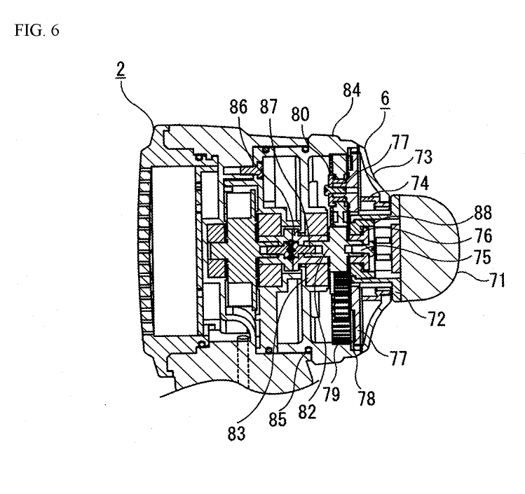

In FIG. 6, the components of the shower head are denoted by the same reference numerals as those in FIG. 4 and are not described. The dead skin exfoliation attachment 6 in FIG. 6 has an outer face composed of a dead skin exfoliating body 84, a pumice cover 93, a pumice base 92, and a pumice 71. An O-ring 85 is disposed between the dead skin exfoliating body 84 and the main head body 14 to provide sealing therebetween. The dead skin exfoliation attachment 6 includes a second cooperating rotary shaft (B) 86 rotatable in cooperation with the first cooperating rotary shaft (A) 20 extending from the fin-driving water chamber 23, a sun gear 79, a planetary gear 82, and an internal gear bush 78 that provide a planetary reduction gear mechanism for a reduction in rotation rate of the second cooperating rotary shaft (B) 86, and a rotation base 77 in this order. The rotation rate of the second cooperating rotary shaft (B) 86 is reduced to that of the rotation base 77 by the reduction gear mechanism. The rotation of the rotation base 77 is transmitted to the pumice 71.

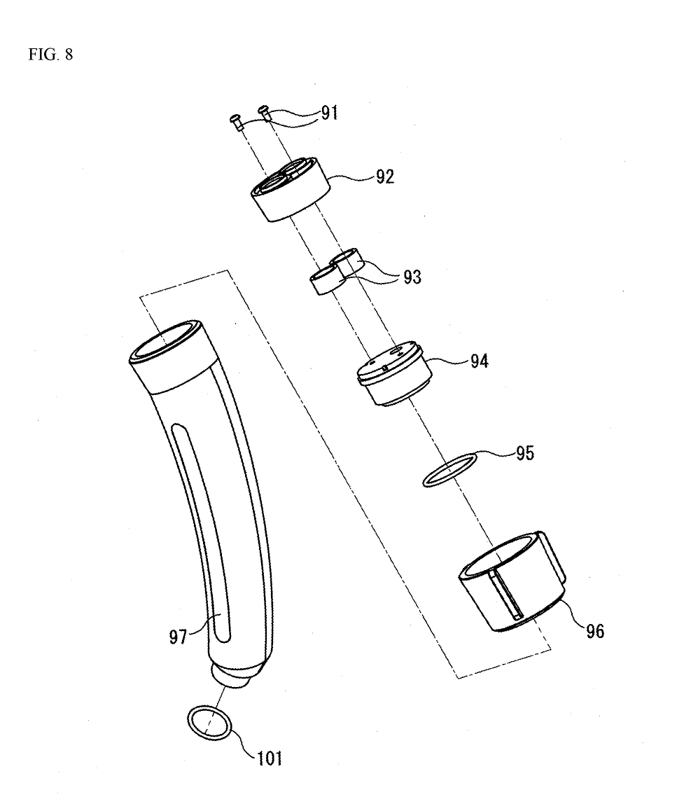

FIG. 7 is an exploded perspective view of a grip, a shower head, and a body brushing attachment. The grip 3 is mounted to the shower head 2 by, for example, tucking. The sealing against the running water can be provided by, for example, an O-ring disposed between a fin-driving water inlet 29 (or a showering water inlet 28) and one end of a water feeding channel 98 (the downstream end of the water feeding channel) illustrated in FIG. 7. An attachment, for example, the body brushing attachment 5 can be mounted to the shower head 2 by fitting of a joint protrusion 100 on the attachment into a joint depression 99 in the shower head and by circumferential rotation of the joint protrusion 100. FIG. 8 is an exploded perspective view of the grip 3. The grip 3 is provided with grip rubbers 97 on the both sides. The grip 3 is provided with a joint 96 at the top end. The joint 96 is provided with an O-ring 95, a grip joint 94, a sealing rubber 93, a sealing rubber holder 92, and screws 91 in this order in the interior. The joint 96 can be mounted to the grip by, for example, tucking. The grip joint 94 has a through-holes facing a non-through-hole (blind hole). The grip joint 94 is fitted into the joint 96, and then the joint 96 is rotated in the circumferential direction such that the through-hole is disposed relative to any of the showering water inlet 28 and the fin-driving water inlet 29 that extend from the shower head 2. Then the joint 96 can be mounted to the shower head 2 by, for example, tucking. The running water from the water feeding channel 98 can be switched to the inlet into the showering water chamber or the inlet into the fin-driving water chamber in the grip 3 after dismount of the grip 3 from the shower head 2; while the joint 96 is rotated in the circumferential direction as described above, the through-hole is disposed relative to any of the showering water inlet 28 and the fin-driving water inlet 29. The joint 96 is then locked to the shower head 2.

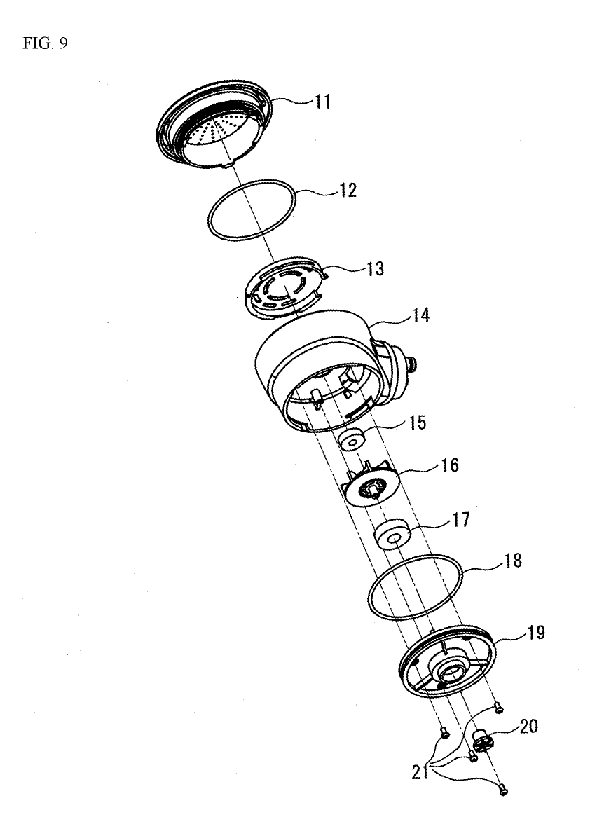

FIGS. 9 to 12 are exploded perspective views of a shower head, a massage attachment, a body brushing attachment, and a dead skin exfoliation attachment, respectively. As illustrated in the exploded view of FIG. 9, the shower head 2 includes, the sprinkling plate 11, the O-ring 12, the watering guide 13, the main head body 14, the bearing 15, the fin 16, the bearing 17, the O-ring 18, the fin holder 19, the first cooperating rotary shaft (A) 20, and screws 21 in this order.

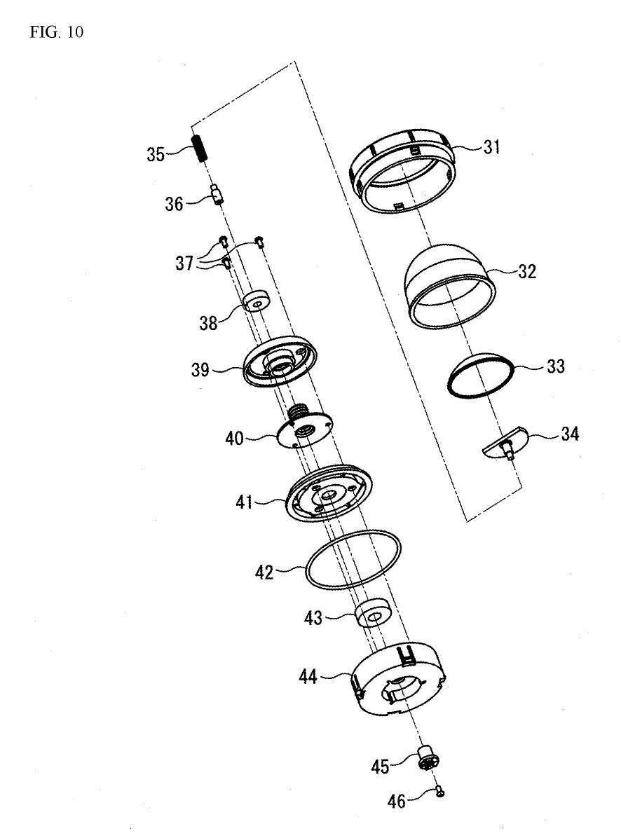

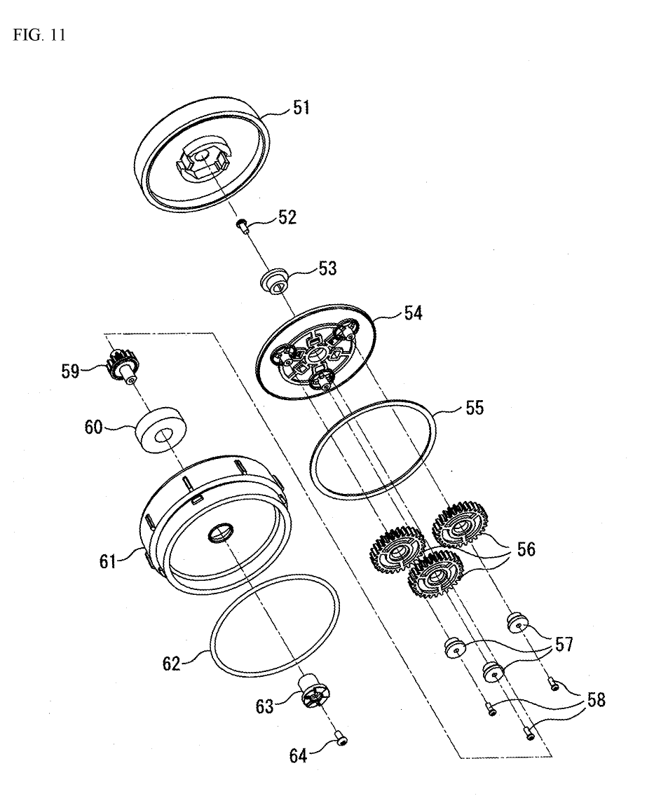

As illustrated in the exploded perspective view of FIG. 10, the massage attachment 4 includes a vibrator body 31, a vibrator rubber 32, an inner vibrator cover 33, an eccentric rotor 34, a rotary spring 35, spring shaft 36, screws 37, a bearing 38, an inner vibrator casing 39, a fixing spring 40, a fixing spring base 41, an O-ring 42, a bearing 43, a vibrator base 44, a second cooperating rotary shaft (B) 45, and a screw 46 in this order. As illustrated in the exploded perspective view of FIG. 11, the body brushing attachment 5 includes a brush base 51, a screw 52, a sun gear bush 53, a rotation base 54, internal gear bushes 55, planetary gears 56, planetary gear bushes 57, screws 58, a sun gear 59, a bearing 60, a brush body 61, an O-ring 62, a second cooperating rotary shaft (B) 63, and a screw 64 in this order.

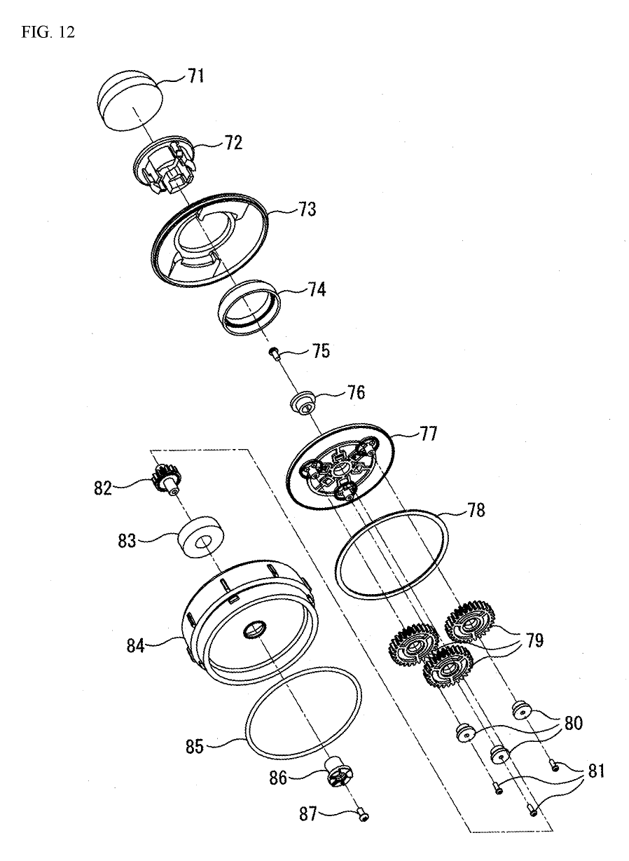

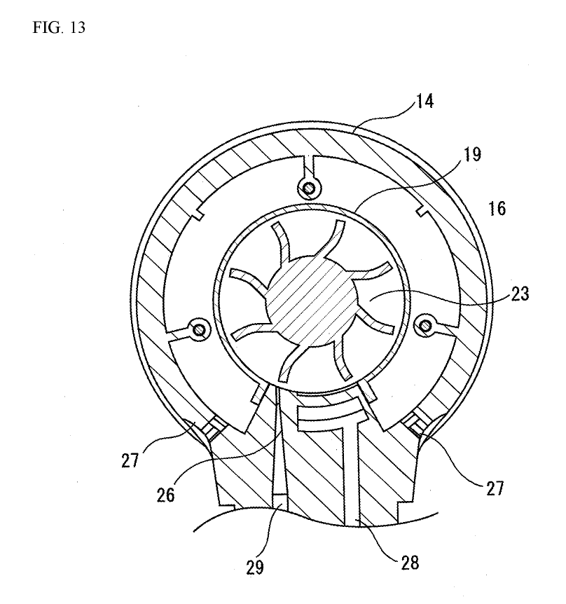

As illustrated in the exploded perspective view of FIG. 12, the dead skin exfoliation attachment 6 includes a pumice 71, a pumice base 72, a pumice cover 73, a pumice base bush 74, a screw 75, a sun gear bush 76, a rotation base 77, an internal gear bush 78, planetary gears 79, planetary gear bushes 80, screws 81, a sun gear 82, a bearing 83, a dead skin exfoliating body 84, an O-ring 85, a second cooperating rotary shaft (B) 86, and a screw 87 in this order. FIG. 13 is a cross-sectional view taken long line A-A in FIG. 4, in other words, a cross-sectional view of a component holding the fin-driving water chamber 23 of the shower head 2 in FIG. 4. The running water from the fin-driving water inlet 29 is discharged from the fin nozzle 26 to the blades of the fin 16 to cause the fin 16 to rotate and is subsequently discharged from a drain 27. The fin holder 19 is provided for effective rotation of the fin 16 by water flow. The shower device (first embodiment) and the second embodiment according to the present invention will now be described.

### 1. Shower Device (First Embodiment)

The shower device according to the first embodiment of the present invention includes: a grip including a water feeding channel therein, and a shower head including a showering water chamber provided with a sprinkling plate and a fin-driving water chamber behind the showering water chamber, in which the fin-driving water chamber accommodates a fin rotatable by running water.

The fin-driving water chamber has an outer face to which an attachment is mountable, and the fin-driving water chamber includes a means to transmit a rotational motion of the fin to the attachment after being mounted.

### (1) Shower Device

The shower device according to the present invention includes: a grip including a water feeding channel therein, and a shower head including a showering water chamber provided with a sprinkling plate and a fin-driving water chamber behind the showering water chamber, in which the fin-driving water chamber accommodates a fin rotatable by running water.

### (1-1) Grip

As illustrated in FIGS. 7 and 8, the grip serves as a handle in use of the multifunctional shower device and a water feeder supplying water to the shower head 2 through the water feeding channel 98. As illustrated in FIG. 8, the grip preferably has a function of switching the water feeding channel 98 in the shower head 2 to the showering water inlet 28 or the fin-driving water inlet 29. For example, the switching can be performed as described above. For example, an O-ring 101 grip may be disposed between a water feeding pipe and the grip 3 to provide sealing therebetween.

### (1-2) Shower Head

As illustrated in FIGS. 4 to 6, the shower head 2 includes the showering water chamber 22 and the fin-driving water chamber 23, which are partitioned by the partition wall 24 being part of the head 11.

### (a) Showering Water Chamber

The showering water chamber 22 has a showering function that sprinkles the running water from the showering water inlet 28 through the sprinkling holes in the sprinkling plate 11. The watering guide 13 is preferably provided for even sprinkling of the water from the sprinkling holes 25.

### (b) Fin-Driving Water Chamber

As illustrated in FIGS. 4 and 13, the fin-driving water chamber has the following functions: generation of the rotational motion of the fin, the mount of the attachment to the outer face of the fin-driving water chamber, and transmission of the rotational motion of the fin to the mounted attachment. Furthermore, the attachment is preferably mountable to and dismountable from the outer face of the fin-driving water chamber. Such a structure allows the use of various attachments changeable in one shower head. As illustrated in FIGS. 4 and 13, the fin-driving water chamber may have a structure to enable the fin nozzle 26 to discharge the running water from the fin-driving water inlet 29 to the blades of the fin to generate the rotational motion of the fin and then to discharge the water from the drain 27.

The attachment is preferably mountable to the outer face of the fin-driving water chamber, and is preferably mountable to and dismountable from the outer face of the fin-driving water chamber. For example, as illustrated in FIG. 7, the joint depression 99 is provided on the outer face of the fin-driving chamber, and the joint protrusion 100 is disposed on the attachment. The joint protrusion 100 is fitted into the joint depression 99 and the attachment is then rotated in the circumferential direction, whereby the attachment can be mounted to the shower head 2. The reverse operation allows the dismount of the attachment. The first cooperating rotary shaft (A) as a means for transmitting the rotational motion of the fin to the mounted attachment preferably extends from the fin-driving water chamber and is coaxial with the rotary shaft of the fin. In an exemplary means for transmitting the rotational motion to the mounted attachment, the end of the first cooperating rotary shaft (A) may be profiled so as to mate with the end of the second cooperating rotary shaft (B) of the attachment as illustrated in FIGS. 4 to 6.

### (2) Attachments to be Mounted

The attachment mountable to the shower device according to the present invention may be of any type of attachment operable by the rotational motion transmitted from the fin-driving water chamber. Specifically, exemplary attachments includes an attachment operable by the rotational motion transmitted from the fin-driving water chamber and an attachment operable by the vibrational motion converted from the rotational motion from the fin-driving water chamber. More specifically, exemplary attachments mountable to the shower device include a massage attachment operable by the vibrational motion, and a body brushing attachment and a dead skin exfoliation attachment operable by the rotational motion, as illustrated in FIGS. 4 to 6.

### 2. Multifunctional Shower Device (Second Embodiment)

The multifunctional shower device according to the second embodiment of the present invention includes: a shower device including a grip including a water feeding channel therein and a shower head including a showering water chamber provided with a sprinkling plate and a fin-driving water chamber that is behind the showering water chamber in which the fin-driving water chamber accommodates a fin rotatable by running water, and an attachment mounted to the outer face of the fin-driving water chamber. The fin-driving water chamber includes a means that transmits a rotational motion of the fin to the attachment after being mounted. The mounted attachment is operable by the rotational motion transmitted from the fin-driving water chamber.

The multifunctional shower device according to the present invention includes the shower device according to the first embodiment and an attachment that is mounted to the outer face of the fin-driving water chamber and operable by the rotational motion transmitted from the fin-driving water chamber.

### (1) Shower Device

As illustrated in FIGS. 4 to 7 and 13, the shower includes: a grip including a water feeding channel therein, and a shower head including a showering water chamber provided with a sprinkling plate and a fin-driving water chamber behind the showering water chamber, in which the fin-driving water chamber accommodates a fin rotatable by running water. This shower device has the same configuration as the shower device described in the first embodiment.

### (1-1) Grip

As illustrated in FIGS. 7 and 8, the grip serves as a handle in use of the multifunctional shower device and a water feeder supplying water to the shower head 2 through the water feeding channel 98. As illustrated in FIG. 8, the grip preferably has a function of switching the water feeding channel 98 in the shower head 2 to the showering water inlet 28 or the fin-driving water inlet 29. For example, the switching can be performed as described above. For example, an O-ring 101 grip may be disposed between a water feeding pipe and the grip 3 to provide sealing therebetween.

### (1-2) Shower Head

As illustrated in FIGS. 4 to 6, the shower head 2 includes the showering water chamber 22 and the fin-driving water chamber 23, which are partitioned by the partition wall 24 being part of the head 11.

### (a) Showering Water Chamber

The showering water chamber 22 has a showering function that sprinkles the running water from the showering water inlet 28 through the sprinkling holes in the sprinkling plate 11. The watering guide 13 is preferably provided for even sprinkling of the water from the sprinkling holes 25.

### (b) Fin-Driving Water Chamber

As illustrated in FIGS. 4 and 13, the fin-driving water chamber has the following functions: generation of the rotational motion of the fin, the mount of the attachment to the outer face of the fin-driving water chamber, and transmission of the rotational motion of the fin to the mounted attachment. Furthermore, the attachment is preferably mountable to and dismountable from the outer face of the fin-driving water chamber. Such a structure allows the use of various attachments changeable in one shower head. As illustrated in FIGS. 4 and 13, the fin-driving water chamber may have a structure to enable the fin nozzle 26 to discharge the running water from the fin-driving water inlet 29 to the blades of the fin to generate the rotational motion of the fin and then to discharge the water from the drain 27.

The attachment is preferably mountable to the outer face of the fin-driving water chamber, and is preferably mountable to and dismountable from the outer face of the fin-driving water chamber. For example, as illustrated in FIG. 7, the joint depression 99 is provided on the outer face of the fin-driving chamber, and the joint protrusion 100 is disposed on the attachment. The joint protrusion 100 is fitted into the joint depression 99 and the attachment is then rotated in the circumferential direction, whereby the attachment can be mounted to the shower head 2. The reverse operation allows the dismount of the attachment. The first cooperating rotary shaft (A) as a means for transmitting the rotational motion of the fin to the mounted attachment preferably extends from the fin-driving water chamber and is coaxial with the rotary shaft of the fin. In an exemplary means for transmitting the rotational motion to the mounted attachment, the end of the first cooperating rotary shaft (A) may be profiled so as to mate with the end of the second cooperating rotary shaft (B) of the attachment as illustrated in FIGS. 4 to 6.

### (2) Attachment

The attachment mountable to the shower device may be of any type operable by a rotational motion transmitted from the fin-driving water chamber. The attachment is preferably operable by the transmitted rotational motion or the vibrational motion converted from the transmitted rotational motion. Specifically, exemplary attachments include a massage attachment operable by the vibrational motion and a body brushing attachment and a dead skin exfoliation attachment operable by the rotational motion, which will be described below. Each attachment is preferably provided with a second cooperating rotary shaft (B) that cooperates with the first cooperating rotary shaft (A) and is operable by the rotational motion transmitted from the fin-driving water chamber. The attachments will now be described below.

### (2-1) Massage Attachment

The massage attachment is mountable to the outer face of the fin-driving water chamber. The massage attachment includes a means for receiving the rotational motion from the rotary shaft disposed adjacent to the fin-driving water chamber and a means for converting the rotational motion into a vibrational motion, which can provide a massaging effect on, for example, a human body. An exemplary massage attachment includes a second cooperating rotary shaft (B), a rotary spring, and an eccentric rotor that are rotatably disposed in this order. The second cooperating rotary shaft (B) is rotatable in cooperation with the first cooperating rotary shaft (A) that extends at least from the fin-driving water chamber and is coaxial with the rotary shaft of the fin. The eccentric rotor converts the rotational motion into the vibrational motion. The massage attachment further includes a vibrating mechanism transmitting the vibrational motion to a massaging member disposed on the end face remote from the mount face of the attachment. The massage attachment can provide the massaging function using the vibrational motion that the eccentric rotor converts from the rotational motion generated by the fin without a reduction in rotational motion. As required, the massage attachment may include a reduction gear mechanism reducing the rotation rate or an accelerating mechanism, which will be described below with the respect to the body brushing attachment, to vary the rotation rate and subsequently convert the rotational motion into the vibrational motion.

An exemplary massage attachment will now be described with reference to FIGS. 4 and 10. As illustrated in FIG. 10, the massage attachment includes a second cooperating rotary shaft (B) 45, a vibrator base 44, a bearing 43, an O-ring 42, a fixing spring base 41, a fixing spring 40, an inner vibrator casing 39, a bearing 38, screws 37, a spring shaft 36, a rotary spring 35, and an eccentric rotor 34 almost in this order for transmission of the rotational motion from the fin-driving water chamber via the first cooperating rotary shaft (A) to the eccentric rotor. The rotary spring 35 is preferably provided with the fixing spring 40 around its outer circumference for reinforcement, resulting in a reduction in the load on the rotary spring 35. Among these components, the component(s) requiring intensity are preferably composed of anticorrosive metal or reinforced plastic, the eccentric rotor 34 is preferably composed of metal, and the component(s) requiring, for example, sliding ability or wear resistance are preferably composed of plastics such as polyacetal resins.

A vibratory mechanism converting the rotational motion into the vibrational motion at the eccentric rotor 34 to transmit the rotational motion to the massaging member consists of the eccentric rotor 34, an inner vibrator cover 33, a vibrator rubber 32, and a vibrator body 31 almost in this order. Among these components, the vibrator rubber 32 providing the massaging function is preferably composed of an elastomer, and other component(s) requiring some degree of intensity are preferably composed of anticorrosive metal or metal having some degree of durability.

### (2-2) Body Brushing Attachment

The body brushing attachment is mountable to the outer face of the fin-driving water chamber. The body brushing attachment includes a means for receiving the rotational motion from the rotary shaft disposed adjacent to the fin-driving water chamber and a brushing member operable by the rotational motion to provide a body brushing effect on, for example, a human body. An exemplary massage attachment includes a second cooperating rotary shaft (B) and a reduction gear mechanism that are rotatably disposed in this order. The second rotary shaft is rotatable in cooperation with the first cooperating rotary shaft (A) that extends at least from the fin-driving water chamber and is coaxial with the rotary shaft of the fin. The reduction gear mechanism reduces the rotational rate of the second cooperating rotary shaft (B). The body brushing attachment further includes a rotating mechanism transmitting the rotational motion reduced by the reduction gear mechanism to a body brushing member disposed on the end face remote from the mount face of the attachment. In the case of a relatively high rotational rate generated by the fin, the body brushing attachment preferably includes, for example, a planetary gear mechanism reducing the rotational rate and subsequently transmitting the rotational motion to the body brushing member. In the case of a relatively low rotational rate, the rotational motion can be transmitted to the body brushing member without use of a decelerating mean such as the reduction gear mechanism described above.

An exemplary body brushing attachment will now be described with reference to FIGS. 5 and 11. The body brushing attachment includes a screw 64, a second cooperating rotary shaft (B) 63, an O-ring 62, a brush body 61, a bearing 60, a sun gear 59, screws 58, planetary gear bushes 57, planetary gears 56 almost in this order for transmission of the rotational motion from the fin-driving water chamber to the planetary gears or reducing gears via the first cooperating rotary shaft (A). The planetary gear mechanism transmitting the rotation of the sun gear 59 to the brush base 51 includes planetary gears 56, an internal gear bush 55, a rotation base 54, a sun gear bush 53, a screw 52, and a brush base 51 almost in this order.

Among these components, the component(s) requiring mechanical intensity are preferably composed of anticorrosive metals or reinforced plastics, and the component(s) requiring sliding ability or wear resistance are preferably composed of plastics such as polyacetal resins. The brush base 51 may include a brushing member composed of, for example, a resilient synthetic resin or animal hair. The gear reduction ratio of the sun gear 59 to the planetary gear mechanism preferably ranges from 1/3 to 1/8. The planetary gear mechanism can achieve a high gear reduction ratio and high torque using a small number of gear stages.

### (2-3) Dead Skin Exfoliation Attachment

The dead skin exfoliation attachment is mountable to the outer face of the fin-driving water chamber. The dead skin exfoliation attachment includes a means receiving the rotational motion from the rotary shaft disposed adjacent to the fin-driving water chamber and a brush base that is composed of pumice and operable by the rotational motion to provide dead skin exfoliating effect on, for example, a human body. An exemplary dead skin exfoliation attachment includes a second cooperating rotary shaft (B) and a reduction gear mechanism that are rotatably disposed in this order. The second cooperating rotary shaft (B) is rotatable in cooperation with the first cooperating rotary shaft (A) that extends at least from the fin-driving water chamber and is coaxial with the rotary shaft of the fin. The dead skin exfoliation attachment also includes a rotating mechanism transmitting the rotational motion reduced by the reduction gear mechanism to a dead skin exfoliating member disposed on the end face remote from the mount face of the attachment. In the case of a relatively high rotational rate generated by the fin, the dead skin exfoliation attachment preferably includes, for example, a planetary gear mechanism reducing the rotational rate and subsequently transmitting the rotational motion to the dead skin exfoliation member. In the case of a relatively low rotational rate, the rotational motion can be transmitted to the dead skin exfoliation member without use of a decelerating mean such as the reduction gear mechanism described above.

An exemplary dead skin exfoliation attachment will now be described with reference to FIGS. 6 and 12. The dead skin exfoliation attachment includes a screw 87, a second cooperating rotary shaft (B) 86, an O-ring 85, a dead skin exfoliating body 84, a bearing 83, a sun gear 82, screws 81, planetary gear bushes 80, planetary gears 79, an internal gear bush 78, and a rotation base 77 almost in this order for transmission of the rotational motion from the fin-driving water chamber to the planetary gears or reducing gears via the first cooperating rotary shaft (A). The planetary gear mechanism transmitting the rotation of the sun gear 82 to the pumice 71 consists of a rotation base 77, a sun gear bush 76, a screw 75, a pumice base bush 74, a pumice cover 73, a pumice base 72, and pumice 71 almost in this order.

Among these components, the component(s) requiring mechanical intensity are preferably composed of anticorrosive metal or reinforced plastic. The component(s) requiring, for example, sliding ability or wear resistance are preferably composed of plastics such as polyacetal resins. The pumice 71 may be composed of natural or synthetic pumice with a predetermined shape. The gear reduction ratio of the sun gear 82 to the planetary gear mechanism preferably ranges from 1/3 to 1/8. The planetary gear mechanism can achieve a high gear reduction ratio and a high torque using a small number of gear stages.

### DENOTATION OF REFERENCE NUMERALS

1 multifunctional shower device
2 shower head
3 grip
4 massage attachment
5 body brushing attachment
6 dead skin exfoliation attachment
11 sprinkling plate
13 watering guide
14 head main body
16 fin
19 fin holder
20 first cooperating rotary shaft (A)
22 showering water chamber
23 fin-driving water chamber
24 partition wall
25 sprinkling holes
27 drain
28 showering water inlet
29 fin-driving water inlet
31 vibrator body
32 vibrator rubber
33 inner vibrator cover
34 eccentric rotor
35 rotary spring
36 spring shaft
39 inner vibrator casing
40 fixing spring
41 fixing spring base
44 vibrator base
45 second cooperating rotary shaft (B)
51 brush base
53 sun gear bush
54 rotation base
55 internal gear bush
56 planetary gear
57 planetary gear bush
59 sun gear
61 brush body
63 second cooperating rotary shaft (B)
71 pumice
72 pumice base
73 pumice cover
74 pumice base bush
76 sun gear bush
77 rotation base
78 internal gear bush
79 planetary gear
80 planetary gear bush
82 sun gear
84 dead skin exfoliating body
86 second cooperating rotary shaft (B)
92 sealing rubber holder
93 sealing rubber
94 grip joint
96 joint
97 grip rubber
98 water feeding channel
99 joint depression
100 joint protrusion

1. A shower device comprising:
a grip comprising a water feeding channel therein, and
a shower head comprising a showering water chamber provided with a sprinkling plate and a fin-driving water chamber behind the showering water chamber, the fin-driving water chamber accommodating a fin rotatable by running water, wherein:
the fin-driving water chamber has an outer face to which an attachment is mountable; and
the fin-driving water chamber comprises a first cooperating rotary shaft to transmit a rotational motion of the fin to the attachment after being mounted, the first cooperating rotary shaft extending from the fin-driving water chamber and being coaxial with a rotary shaft of the fin.

2. The shower device according to claim 1, wherein the attachment is mountable to and dismountable from the outer face of the fin-driving water chamber.

3. The shower device according to claim 1, wherein the grip comprises a switch that changes the flow of the water to a showering water chamber inlet or a fin-driving water chamber inlet.

4. The shower device according to claim 1, wherein:
the showering water chamber and the fin-driving water chamber disposed in the shower head are partitioned by a partition wall, the showering water chamber having a structure capable of sprinkling the running water from the showering water chamber inlet through sprinkling holes in the sprinkling plate; and
the fin-driving water chamber has a structure capable of discharging the running water from the fin-driving water chamber inlet through a fin nozzle to blades of the fin and generating a rotational motion of the fin, the running water being discharged from a drain of the fin-driving water chamber.

5. The shower device according to claim 1, wherein the mounted attachment is operable by the rotational motion transmitted from the fin-driving water chamber.

6. The shower device according to claim 1, wherein the mounted attachment is operable by the rotational motion transmitted from the fin-driving water chamber or by a vibrational motion converted from the rotational motion transmitted from the fin-driving water chamber.

7. A multifunctional shower device comprising:
a shower device comprising a grip comprising a water feeding channel therein and a shower head comprising a showering water chamber provided with a sprinkling plate and a fin-driving water chamber behind the showering water chamber, the fin-driving water chamber accommodating a fin rotatable by running water, and
an attachment mounted to the outer face of the fin-driving water chamber, wherein:
the fin-driving water chamber comprises a first cooperating rotary shaft to transmit a rotational motion of the fin to the attachment after being mounted, the first cooperating rotary shaft extending from the fin-driving water chamber and being coaxial with a rotary shaft of the fin; and
the mountable attachment comprises a second cooperating rotary shaft cooperating with the first cooperating rotary shaft, the attachment being operable by the rotational motion transmitted from the fin-driving water chamber.

8. The multifunctional shower device according to claim 7, wherein the attachment is mountable to and dismountable from the outer face of the fin-driving water.

9. The multifunctional shower device according to claim 7, wherein the grip comprises a switch that changes the flow of the water to a showering water chamber inlet or a fin-driving water chamber inlet.

10. The multifunctional shower device according to claim 7, wherein:
the showering water chamber and the fin-driving water chamber disposed in the shower head are partitioned by a partition wall, the showering water chamber having a structure capable of sprinkling the running water from the showering water chamber inlet through sprinkling holes in the sprinkling plate; and
the fin-driving water chamber has a structure capable of discharging the running water from the fin-driving water chamber inlet through a fin nozzle to blades of the fin and generate a rotational motion of the fin, the running water being discharged from a drain of the fin-driving water chamber.

11. The multifunctional shower device according to claim 7, wherein the attachment is operable by the rotational motion transmitted from the fin-driving water chamber or by a vibrational motion converted from the rotational motion transmitted from the fin-driving water chamber.

12. The multifunctional shower device according to claim 11, wherein
the attachment operable by the rotational motion transmitted from the fin-driving water chamber is a body brushing attachment or a dead skin exfoliation attachment, or the attachment operable by the vibrational motion converted from the rotational motion transmitted from the fin-driving water chamber is a massage attachment.

13. The multifunctional shower device according to claim 12, wherein:
the massage attachment comprises a second cooperating rotary shaft, a rotary spring, and an eccentric rotor that are rotatably disposed in this order, the second cooperating rotary shaft being rotatable in cooperation with the first cooperating rotary shaft that extends at least from the fin-driving water chamber and is coaxial with the rotary shaft of the fin, the eccentric rotor converting the rotational motion into the vibrational motion; and
the massage attachment further comprises a vibrating mechanism transmitting the vibrational motion to a massaging member disposed on an end face remote from a mount face of the attachment.

14. The multifunctional shower device according to claim 12, wherein:
the body brushing attachment comprises a second cooperating rotary shaft and a reduction gear mechanism that are rotatably disposed in this order, the second cooperating rotary shaft being rotatable in cooperation with the first cooperating rotary shaft that extends at least from the fin-driving water chamber and is coaxial with the rotary shaft of the fin, the reduction gear mechanism reducing the rotational rate of the second cooperating rotary shaft; and
the body brushing attachment further comprises a rotating mechanism transmitting the rotational motion reduced by the reduction gear mechanism to a body brushing member disposed on the end face remote from the mount face of the attachment.

15. The multifunctional shower device according to claim 12, wherein:
the dead skin exfoliation attachment comprises a second cooperating rotary shaft and a reduction gear mechanism that are rotatably disposed in this order, the second cooperating rotary shaft being rotatable in cooperation with the first cooperating rotary shaft that extends at least from the fin-driving water chamber and is coaxial with the rotary shaft of the fin, the reduction gear mechanism reducing the rotational rate of the second cooperating rotary shaft, and
the dead skin exfoliation attachment further comprises a rotating mechanism transmitting the rotational motion reduced by the reduction gear mechanism to a dead skin exfoliating member disposed on the end face remote from the mount face of the attachment.
